(19) United States
(12) Patent Application Publication
(10) Pub. No.: US 2006/0035746 A1
(43) Pub. Date: Feb. 16, 2006

(54) Drive shaft assembly and method of separation

(76) Inventors: Steven H. Griggs, West Bend, WI (US); John G. Kossoris, Brookfield, WI (US); Michael Mitchell, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 10/916,729

(22) Filed: Aug. 12, 2004

(51) Int. Cl. F16H 57/08

(52) U.S. Cl. 475/331

(57) ABSTRACT

A shaft assembly includes first and second shafts that are easily separable. The first shaft has a longitudinal axis, and includes an output end having an axially opening cavity. The second shaft has an end received in the axially opening cavity. A passageway is formed through one of the first and second shafts and is in fluid communication with the cavity for pumping a fluid through the passageway into the cavity between the first and second shafts to axially urge the second shaft out of the cavity.

### CROSS REFERENCES TO RELATED APPLICATIONS

Not Applicable.

### STATEMENT REGARDING FEDERALLY SPONSORED RESEARCH

Not Applicable

### BACKGROUND OF THE INVENTION

The field of invention is shaft assemblies, and more particularly to a drive shaft assembly that is easily separable and a method for separating a pair of frictionally engaged shafts.

Drive shaft assemblies can be used to rotatably drive rotatably driven machinery. A common shaft assembly is a concentric speed reducer, such as a Titan Planetgear™ Speed Reducer available from Rexnord Industries, Inc., Milwaukee, Wis. The Planetgear™ speed reducer is a concentric shaft speed reducer that uses a simple planetary design known in the art.

The planetary design utilizes a rotatably driven sun gear as an input, a stationary ring gear as a fixed element, and a planetary carrier as an output. The planetary carrier includes a plurality of rotatably mounted planetary gears that are interposed between and engage the sun gear and ring gear. The sun gear rotatably drive the planetary gears which rotate the planetary carrier in a direction opposite to the direction of rotation of the sun gear and at a rotational speed that is less than the rotational speed of the sun gear.

The combination of the sun gear, ring gear, and carrier of the planetary design is called a reduction. The planetary carrier can rotatably drive a second sun gear forming part of a second reduction to which rotatably drives a second planetary carrier at an even lower rotational speed. Any number of reductions can be used to attain the desired reduction of speed from the first sun to the last planetary carrier.

The planetary carrier of the last reduction of a speed reducer rotatably drives an output shaft that is coupled to an input shaft of a rotatably driven machine. The last planetary carrier is typically pressed onto the output shaft, such that the planetary gear frictionally engages the shaft. Splines and other methods can also be used to rotatably fix the shaft relative to the planetary carrier, such that rotational forces are efficiently transmitted from the planetary carrier to the shaft.

After a relatively short period of time in service, the output shaft and last planetary gear carrier become fused together as a result of fretting. This condition worsens as the fretting between the carrier and output shaft continues. Moreover, if the output shaft is received in a cavity formed in the carrier, if the output shaft is spaced from a closed end of the cavity, a strong suction is often created in the space between the output shaft and cavity closed end.

When disassembling a speed reducer, separation of the output shaft from the planetary carrier is often necessary. Unfortunately, separating the output shaft from the planetary carrier can be extremely difficult because of the suction and fretting between the carrier and output shaft. As a result, disassembly may require cutting the carrier away from the shaft which is time consuming, expensive, and results in the destruction of the carrier, shaft, or both. Therefore, a need exists for a carrier and a method of separation that provides for easy separation of an output shaft from the carrier.

### BRIEF SUMMARY OF THE INVENTION

The present invention provides a drive shaft assembly including first and second shafts that are easily separable and a method for separating the shafts. The first shaft has a longitudinal axis, and includes an output end having an axially opening cavity. The second shaft has an end received in the axially opening cavity. A passageway is formed through one of the first and second shafts and is in fluid communication with the cavity for pumping a fluid through the passageway into the cavity between the first and second shafts to axially urge the second shaft out of the cavity.

A general objective of the present invention is to provide a shaft assembly including frictionally engaged shafts that are easily separable. This objective is accomplished by forming a passageway in one of the shafts for pumping a fluid through the passageway between the first and second shafts to separate the frictionally engaged shafts.

The foregoing and other objectives and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a sectional elevation view of a triple reduction speed reducer incorporating the present invention; and

FIG. 2 is a sectional elevational view of the planetary carrier of FIG. 1.

### DETAILED DESCRIPTION OF THE PREFERRED EMBODIMENTS

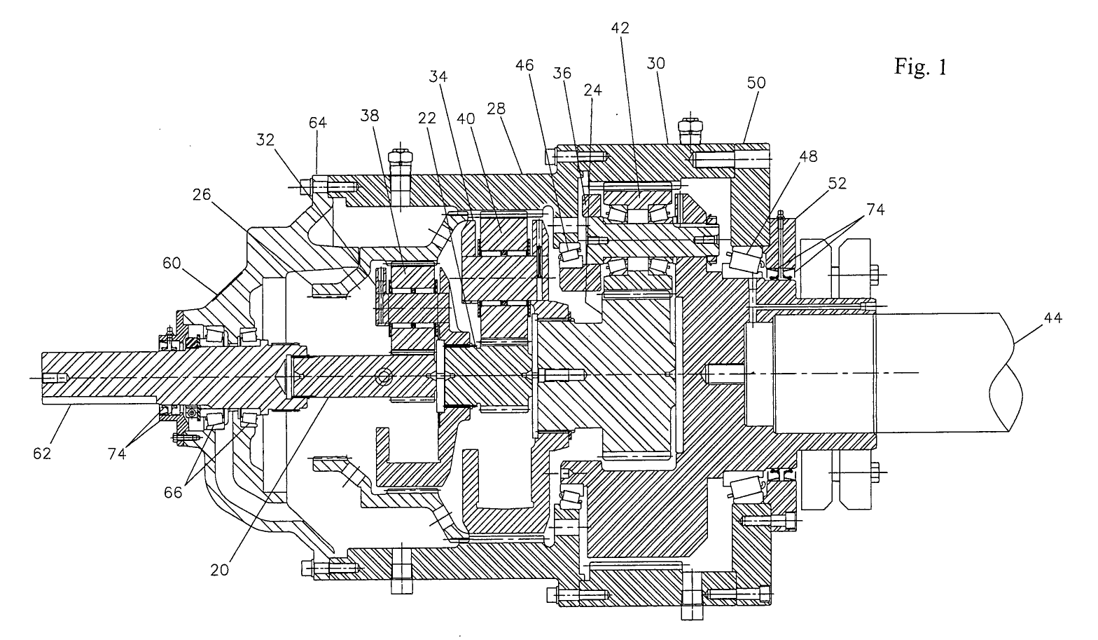

As shown in FIG. 1, a triple reduction speed reducer 10 incorporating the present invention includes three reductions. Each reduction includes one of a rotatably driven sun gear 20, 22, 24, a ring gear 26, 28, 30 which is fixed from rotating, and a planetary gear assembly 32, 34, 36 including a plurality of planetary gears 38, 40, 42. The first reduction comprises sun gear 20, ring gear 26, and planetary gear assembly 32. The second reduction comprises sun gear 22, ring gear 28, and planetary gear assembly 30. The third, and last, reduction comprises sun gear 24, ring gear 30, and planetary gear assembly 42. Although the triple reduction speed reducer 10 is described, the present invention can be incorporated into a speed reducer, or other drive shaft assembly, having any number of reductions without departing from the scope of the invention.

The sun gear 20 of the first reduction is rotatably driven by an input assembly 60. The input assembly 60 includes an input drive shaft 62 coupled to the first reduction sun gear 20, such as by a spline, press fit, and the like. The input shaft 62 extends axially through a front cover 64 fixed to the ring gear 28, such as by a plurality of bolts. Bearings 66 are mounted in the front cover 64 to rotatably support the input drive shaft 62 and reduce friction. Preferably, seals 74 fixed relative to the front cover 64 sealingly engage the input shaft drive shaft 62 to prevent lubrication from leaking out of the reducer 10.

The rotatably driven input drive shaft 62 rotatably drives the sun gear 20 of the first reduction which, as is known in the art, rotatably drives the first reduction planetary gear assembly 32. The planetary gear assembly 32 of the first reduction is coupled to, and rotatably drives, the sun gear 22 of the second reduction which rotatably drive the second reduction planetary gear assembly 34. Likewise, the planetary gear assembly 34 of the second reduction is coupled to, and rotatably drives, the sun gear 24 of the third, and last, reduction which rotatably drives the last reduction planetary gear assembly 36 which rotatably drives a coaxial output shaft 44. The output shaft 44 can be coupled to a rotatably driven machine (not shown) to rotatably drive the rotatably driven machine.

The last reduction planetary gear assembly 36 is rotatably supported by bearing 46, 48. Bearing 46 are interposed between the last reduction planetary gear assembly 36 and ring gear 28. Bearings 48 are interposed between the last reduction planetary gear assembly 36 and the retaining plate 50. The output shaft 44 of the speed reducer 10 extends through a seal cover 52 fixed to a retaining plate 50, such as by bolts. Preferably, a seal carrier 52 fixed to the retaining plate 50, such as by bolts, supports seals 74 sealingly engaging the output shaft 44 to prevent lubrication from leaking out of the reducer 10. Advantageously, the bearings 48 can be adjusted by manipulating the clearance between the bearings 48 and seal carrier 52.

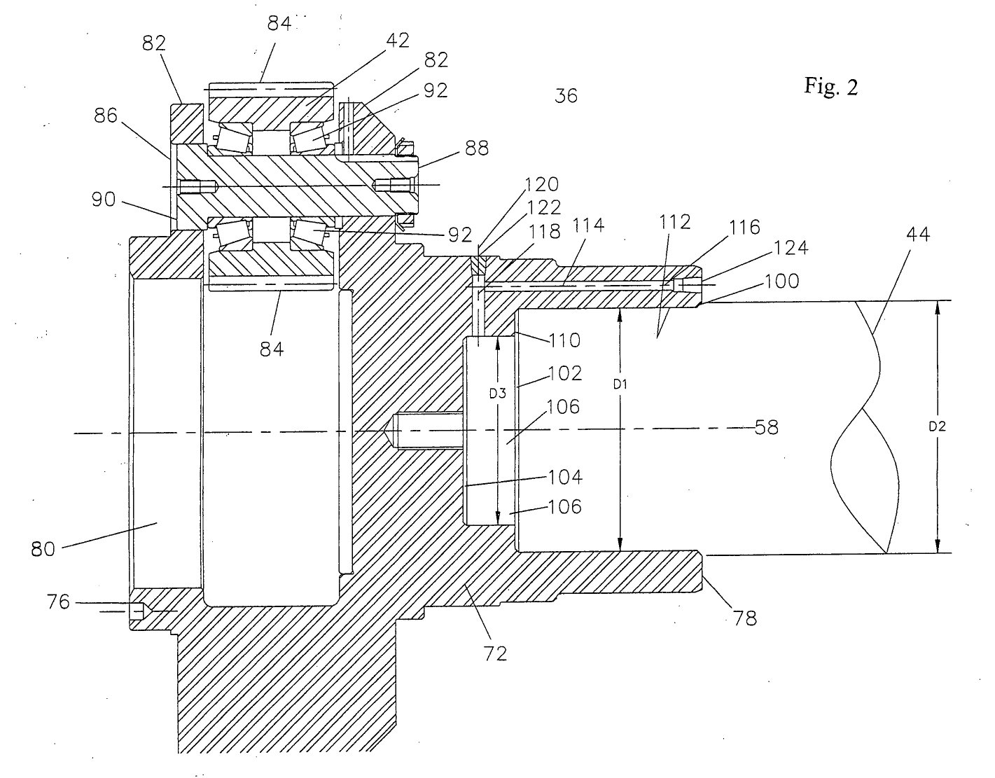

As shown in FIGS. 1 and 2, the planetary gear assembly 36 of the last reduction includes a planetary carrier 72, or body, pressed onto the output shaft 44, such that the carrier 72 frictionally engages the output shaft 44. The carrier 72 is a drive shaft rotatable about a longitudinal axis 58 which extends through an input end 76 and an output end 78 of the carrier 72. The input end 76 of the carrier 72 includes an axially opening cavity 80 for receiving the sun gear 24 of the last reduction. Radially extending mounting ears 82 circumferentially spaced around the carrier 72 rotatably support the planetary gears 42 of the last reduction planetary gear assembly 36.

Each last reduction planetary gear 42 includes radially outwardly projecting teeth 84 that engage the sun gear 24 and the ring gear 30 of the last reduction, such that rotation of the sun gear 24 rotatably drives the planetary gears 42 which rotatably drive the carrier 72. Each last reduction planetary gear 42 is rotatably mounted in one set of the ears 82 by a planetary gear shaft 86 supported at opposing ends 88, 90 by the ears 82. Bearings 92 surrounding the shaft 86 rotatably support the planetary gear 42 to minimize friction.

The output end 78 of the carrier 72 includes an axially opening cavity 100 having a first inner diameter D1 substantially equal to the outer diameter D2 of the output shaft 44 for receiving an end 102 of the output shaft 44. An axially inner end 104 of the cavity 100 is closed, and the output shaft end 102 received in the cavity 100 is spaced from the cavity inner end 104 to define a space 106 between the output shaft end 102 and the inner end 104 of the cavity 100. Preferably, the output shaft 44 is pressed into the cavity 100 to efficiently transfer rotational forces from the carrier 72 to the output shaft 44. A pilot hole 108 in the cavity inner end 104 may be formed during fabrication of the carrier 72.

Preferably, the output shaft end 102 abuts a shoulder 110 formed in an internal wall 112 of the cavity 100 to define the space 106 between the output shaft end 102 and the cavity inner end 104. In the embodiment disclosed herein, the cavity 100 has a first inner diameter D1 of approximately 5.709 inches for receiving the output shaft 44 having the substantially same diameter. The space 106 defined between the output shaft end 102 and the closed inner end 104 of the cavity 100 has a second inner diameter D3 of approximately 5.0 inches which extends from the first inner diameter D1 toward the inner end 104 of the cavity 100 to form the shoulder 110. Although a shoulder 110 having a height of approximately 0.7 inches is disclosed, the shoulder 110 can be omitted or the space 106 can have any diameter that is different from the output shaft diameter D2 without departing from the scope of the invention. Preferably, however, the output shaft 44 does not extend any further into the cavity 100 than the extent of the first inner diameter D1 of the cavity 100. Moreover, although a specific output shaft outer diameter and cavity inner diameter are disclosed, the cavity inner diameter can be sized to accommodate any shaft outer diameter without departing from the scope of the invention.

Referring to FIG. 2, a passageway 114 formed through the carrier 72 is in fluid communication with the cavity 100, such that fluid can be pumped into the space 106 to axially urge the carrier 72 and output shaft 44 axially apart. Preferably, the passageway 114 is formed by drilling an axially extending hole 116, such as a 0.25 inch diameter hole, from the carrier output end 78 which intersects a radially extending hole 118, such as a 0.344 inch diameter hole, that is in fluid communication with the cavity 100. The radially outer end 120 of the radially extending hole 118 can then be plugged to form the passageway 114 extending from the output end 78 of the carrier 72 to the space 106 between the cavity inner end 104 and the output shaft end 102 received in the cavity 100. Although two holes, each having a 0.25 inch diameter and a 0.344 inch diameter, respectively, are disclosed to formed the passageway, any number of holes having any desired diameter, such as a single angled hole having a diameter ranging from 0.2 inches to 0.5 inches can be used to form the passageway without departing from the scope of the invention.

In the embodiment disclosed herein, the radially outer end 120 of the radially extending hole 118 is preferably threaded for threadably engaging a high pressure threaded plug 122. The axially outer end 124 of axially extending hole 116 is also preferably threaded for threadably engaging a nipple (not shown). The nipple can be easily connected to a source of a fluid that is then pumped through the passageway 114 into the space 106 to separate the output shaft 44 from the carrier 72.

Preferably, the fluid is substantially incompressible, such as hydraulic fluid, at a pressure of approximately 5000 psi in order to slowly urge the output shaft 44 and carrier 72 apart. Of course, the pressure of the fluid necessary to axially urge the output shaft 44 and carrier 72 apart is dependent upon the fit between the carrier 72 and output shaft 44, degree of fretting, and other factors. Accordingly, the pressure of the fluid can be more or less than 5000 psi without departing from the scope of the invention.

Referring to FIGS. 1 and 2, in use, the output shaft 44 of the assemble speed reducer 10 is separated from the carrier 72 of the third reduction by removing the retaining plate 50 to expose the carrier 72. Fluid is pumped into the space 106 between the output shaft end 102 and carrier 72. The fluid can be pumped through the passageway 114 using a pump which forces fluid into the space or by connecting the passageway 114 to a source of pressurized fluid which flows through the passageway 114 into the space 106. The fluid pumped into the space 106 urges the output shaft end 102 out of the cavity 100 without destroying either the carrier 72 or the output shaft 44.

While there have been shown and described what is at present considered the preferred embodiments of the invention, it will be obvious to those skilled in the art that various changes and modifications can be made therein without departing from the scope of the invention defined by the appended claims. For example, the passageway 114 can be formed through the output shaft 44 without departing from the scope of the invention. Moreover, the present invention is not limited to speed reducers, and can be incorporated into any drive shaft assembly having frictionally engaged shafts to must be separated.

We claim:

1. A drive shaft assembly comprising:
a body having a longitudinal axis, said body including an output end having an axially opening cavity for receiving an end of an adjacent shaft;
a passageway formed through said body and in fluid communication with said cavity for pumping a fluid through said passageway into said cavity between said body and the end of the adjacent shaft to axially urge said adjacent shaft out of said cavity.

2. The drive shaft assembly as in claim 1, in which said cavity is defined by an internal wall having a shoulder for abutting the end of the adjacent shaft.

3. The drive shaft assembly as in claim 1, in which said cavity has a first inner diameter and a second inner diameter, said first inner diameter extends from an open end of said cavity toward said second inner diameter, and said second inner diameter extends from said first inner diameter toward a closed end of said cavity, wherein an output shaft received in said cavity extends into said cavity no farther than the extent of said first inner diameter.

4. The drive shaft assembly as in claim 1, in which said passageway is formed by an axially extending hole formed in said body that intersects a radially extending hole formed in said body in fluid communication with said cavity.

5. The drive shaft assembly as in claim 1, in which said body is a planetary carrier forming part of a speed reducer.

6. A method of separating a pair of frictionally engaged shafts, said method comprising:
pumping a fluid into a space between said frictionally engaged shafts to axially urge one of said frictionally engaged shafts relative to the other of said frictionally engaged shafts.

7. The method of separating a pair of frictionally engaged shafts as in claim 6, in which said fluid is substantially incompressible.

8. The method of separating a pair of frictionally engaged shafts as in claim 6, in which one of said frictionally engaged shafts comprises a body having a longitudinal axis, said body including an output end having an axially opening cavity for receiving an end of the other of said frictionally engaged shafts and defining said space therebetween, and a passageway formed through one of said body and said other of said frictionally engaged shafts and in fluid communication with said space, wherein said fluid is pumped through said passageway into said space to axially urge one of said frictionally engaged shafts relative to the other of said frictionally engaged shafts.

9. The method as in claim 8, in which said cavity is defined by an internal wall having a shoulder for abutting the end of the adjacent shaft.

10. The method as in claim 8, in which said cavity has a first inner diameter and a second inner diameter, said first inner diameter extends from an open end of said cavity toward said second inner diameter, and said second inner diameter extends from said first inner diameter toward a closed end of said cavity, wherein an output shaft received in said cavity extends into said cavity no farther than the extent of said first inner diameter.

11. The method as in claim 8, in which said passageway is formed by an axially extending hole that intersects a radially extending hole in fluid communication with said cavity, wherein said holes are formed in one of said frictionally engaged shafts.

12. The method as in claim 8, in which said body is a planetary carrier forming part of a speed reducer.

13. The method as in claim 7, in which said fluid is pumped into said space using a pump.

14. A shaft assembly comprising:
a first shaft having a longitudinal axis, said first shaft including an output end having an axially opening cavity;
a second shaft having an end received in, and frictionally engaging, said axially opening cavity;
a passageway formed through one of said first and second shafts and in fluid communication with said cavity for pumping a fluid through said passageway into said cavity between said first and second shafts to axially urge said second shaft out of said cavity.

15. The shaft assembly as in claim 14, in which said cavity is defined by an internal wall having a shoulder for abutting said end of said second shaft.

16. The shaft assembly as in claim 14, in which said cavity has a first inner diameter and a second inner diameter, said first inner diameter extends from an open end of said cavity toward said second inner diameter, and said second inner diameter extends from said first inner diameter toward a closed end of said cavity, wherein said second shaft received in said cavity extends into said cavity no farther than the extent of said first inner diameter.

17. The shaft assembly as in claim 14, in which said passageway is formed by an axially extending hole that intersects a radially extending hole in fluid communication with said cavity, said first and second holes being formed in one of said first and second shafts.

18. The shaft assembly as in claim 14, in which said first body is a planetary carrier forming part of a speed reducer.

19. The shaft assembly as in claim 14 in which said first shaft is coaxial with said second shaft.

20. The shaft assembly as in claim 14, in which one of said first and second shafts rotatably drives the other of said first and second shafts.
